(19) United States
(12) Patent Application Publication
(10) Pub. No.: US 2010/0323723 A1
(43) Pub. Date: Dec. 23, 2010

(54) Base Station Mapping with Angle-of-Arrival and Timing Advance Measurements

(76) Inventors: Dirk Gerstenberger, Stockholm (SE); Ari Kangas, Lidingo (SE); Daniel Larsson, Solna (SE); Torbjorn Wigren, Uppsala (SE)

Correspondence Address: COATS & BENNETT, PLLC, 1400 Crescent Green, Suite 300, Cary, NC, 27518, US

(21) Appl. No.: 12/486,350

(22) Filed: Jun. 17, 2009

(51) Int. Cl. H04W 24/00

(52) U.S. Cl. 455/456.5

(57) ABSTRACT

Methods and apparatus for determining a position estimate for a base station transceiver node in a wireless communication system are disclosed. Angle-of-arrival and/or timing advance measurements corresponding to transmissions received from mobile stations for which geographic locations are already known are combined with known locations for the mobile stations to estimate the position of the base station receiving the transmissions. This estimated base station position may be used, for example, in subsequent positioning of mobile stations for which locations are not already known, such as mobile stations not equipped with GPS technology. The estimated base station position may also be used to update a database of base station coordinates for the wireless network.

### TECHNICAL FIELD

The present invention relates generally to wireless communications systems, and more particularly to techniques and systems for determining the location of a base station transceiver node in a wireless communication system.

### BACKGROUND

Network-based positioning solutions often depend on the availability of precise location information for each base station (known as an eNodeB in the latest generation of standards developed by the 3^{rd} Generation Partnership Project) in a wireless network. Without this precise location information, for example, mobile station positioning technologies based on timing advance (TA) measurements, angle-of-arrival (AoA) measurements, and/or time-difference-of-arrival (TDOA) measurements cannot be implemented. Because surveying costs can be high, automatic or semi-automatic mapping techniques are needed by many wireless network operators.

Effective automatic surveying techniques would also be useful in detecting erroneous eNodeB coordinates in a positioning solution database. Experience shows that this is a substantial problem in fielded cellular network, the reason likely being the high cost and complexity associated with the surveying of tens of thousands of eNodeBs. The consequences arising from the use of erroneous eNodeB coordinates could include a complete failure of positioning events based on a combination of cell identification and time advance (cell ID/TA positioning) or on the currently standardized Observed-Time-Difference-of-Arrival (OTDOA) method requested. This fact will become clear in the description of existing positioning technology provided below.

Thus, technologies that facilitate self-learning when it comes to determination of eNodeB locations are desirable to wireless network operators.

### SUMMARY

Disclosed herein are various methods and apparatus for determining a position estimate for a base station transceiver node in a wireless communication system. Generally speaking, these methods and apparatus exploit timing advance and/or angle-of-arrival measurements corresponding to transmissions received from mobile stations for which geographic locations are already known. By combining these known locations with corresponding timing advance and/or angle-of-arrival estimates, an estimated base station position can be computed. This estimated base station position may be used, for example, in subsequent positioning of mobile stations for which locations are not already known (e.g., mobile stations not equipped with GPS technology). The estimated base station position may also be used to update a database of base station coordinates for the wireless network.

An exemplary method for determining a position estimate for a base station transceiver node in a wireless communication system thus includes determining a first estimated angle-of-arrival corresponding to a first mobile station transmission, from a first location, received at the base station transceiver node, and determining at least one additional estimated positioning parameter, comprising one or more of (i) an estimated timing advance value for the first mobile station transmission or (ii) a second estimated angle-of-arrival corresponding to a second mobile station transmission, from a second location, received at the base station transceiver node. The method further includes receiving mobile station location data identifying the mobile station position corresponding to each of the first estimated angle-of-arrival and the at least one additional estimated positioning parameter, and computing an estimated position for the base station transceiver node as a function of the mobile station location data, the first estimated angle-of-arrival, and the at least one additional estimated positioning parameter. The first estimated angle-of-arrival may be estimated, in some embodiments, based on signals received from two or more antenna elements co-located with the base station transceiver node.

In some embodiments where the at least one additional estimated positioning parameter comprises an estimated timing advance value for the first mobile station transmission, the estimated position for the base station transceiver node may be computed by calculating base station coordinate offsets as a function of the first angle-of-arrival and the timing advance value, and then calculating the estimated base station position as a function of the mobile station location data corresponding to the first mobile station transmission and the computed base station coordinate offsets. In some of these embodiments, the estimated position may be calculated further as a function of mobile station location data corresponding to one or more additional mobile station transmissions and additional base station coordinate offsets corresponding to the one or more additional mobile station transmissions. Thus, for example, base station position estimates may be based on averaging the estimated base station positions derived from several mobile station transmissions.

In some embodiments where the at least one additional estimated positioning parameter comprises a second angle-of-arrival measurement, computing an estimated position for the base station transceiver node may comprise solving an optimization problem based on the first and second estimated angles-of-arrival and mobile station location data corresponding to the first and second locations. Data from additional mobile station transmissions may be included as well. Thus, in some of these embodiments, the estimated base station position is calculated further as a function of a third estimated angle-of-arrival corresponding to a third transmission from a third location and mobile station location data corresponding to the third location.

In some embodiments, the estimated position is sent to a supporting node in the wireless communication system. In some of these and other embodiments, stored position coordinates for the base station transceiver node are updated, based on the estimated position. In some embodiments, an error in previously stored position coordinates for the base station transceiver node may be detected by comparing the estimated position to the stored position coordinates and determining that the difference between the estimated position and the stored position coordinates exceeds a pre-determined threshold.

In addition to the disclosed methods for estimating base station positions, corresponding apparatus are also disclosed. In particular, position-determining circuits corresponding generally to the methods summarized above are described. In addition, exemplary base station configurations are disclosed. The present invention may, of course, be carried out in other ways than those specifically set forth herein without departing from essential characteristics of the invention. Upon reading the following description and viewing the attached drawings, the skilled practitioner will recognize that the described embodiments are illustrative and not restrictive, and that all changes coming within the scope of the appended claims are intended to be embraced therein

### BRIEF DESCRIPTION OF THE DRAWINGS

FIG. 1 illustrates a mobile phone positioning system utilizing assisted GPS.

FIG. 2 illustrates cell identity positioning combined with timing advance measurements.

FIG. 3 illustrates mobile phone positioning based on time-difference-of-arrival measurements.

FIG. 4 illustrates mobile phone positioning based on angle-of-arrival measurements.

FIG. 5 is a block diagram illustrating an exemplary base station including a positioning-determining circuit.

FIG. 6 is a process flow diagram illustrating an exemplary method for estimating a base station's position.

FIG. 7 is a process flow diagram illustrating a method for detecting configuration errors in a base station position database.

FIG. 8 is a process flow diagram illustrating a method for using an estimated base station position to determine the position of a mobile station.

### DETAILED DESCRIPTION

Disclosed herein are techniques for using mobile station position information for Radio Access Network (RAN) mapping purposes. More specifically, the location of base station transceiver nodes in a wireless network, such as eNodeBs in a 3GPP LTE network, may be automatically surveyed using these techniques. In general, the techniques disclosed herein exploit mobile stations that have access to location data for their own positions (or for which position information is known by another node), such as mobile stations able to determine their own positions using assisted GPS (A-GPS) functionality. As described in detail below, this location data for mobile stations may be combined with angle-of-arrival measurements for transmissions from those mobile stations, timing advance measurements for mobile station transmissions, or both, to determine position estimates for a base station transceiver node.

As noted above, automatic or semi-automatic mapping techniques are needed by many operators, due to the high costs associated with conventional surveying methods. Without accurate eNodeB location data, conventional mobile station positioning technologies are impossible, or at least suffer degraded performance. These conventional mobile station positioning techniques, which are used today for emergency positioning and other location-based services, include timing-advance (TA) positioning, angle-of-arrival (AoA) positioning, and time-difference-of-arrival (TDOA) positioning.

Another application of the techniques disclosed herein is the automatic detection of erroneously configured eNodeB coordinates. As noted above, field experience demonstrates that this is a substantial problem in actual cellular networks. As will be apparent upon review of the survey of mobile station positioning technologies that follows, erroneous position data for an eNodeB in a live network can cause serious problems, or outright failure, of conventional mobile station positioning techniques.

A brief review of cellular positioning technology is given first, to provide a foundation for a detailed description of the invention. Those skilled in the art will appreciate that the mathematical modeling used in the discussion that follows is generally based on a two-dimensional, Cartesian, earth tangential, coordinate system, with its origin somewhere in the RAN of interest. Of course, other spatial mapping systems may be used.

Assisted GPS (A-GPS) Positioning

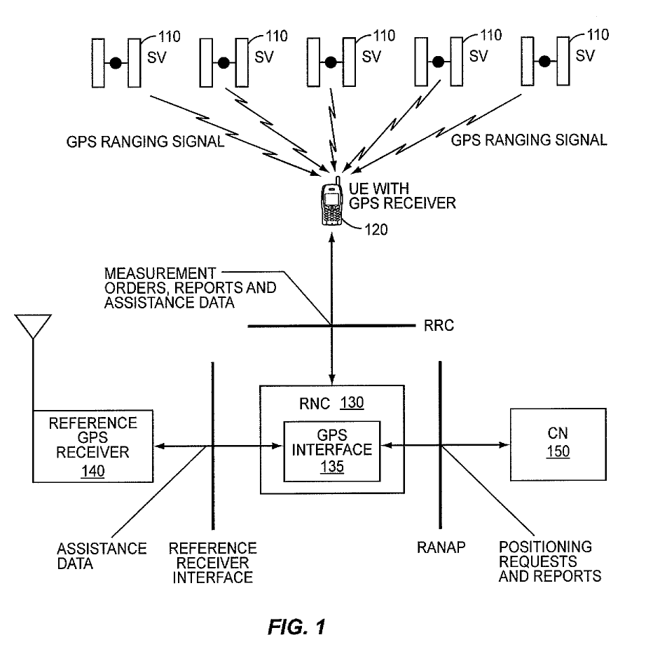

Assisted GPS (A-GPS) positioning is an enhancement of the global positioning system (GPS), allowing a properly equipped mobile station to quickly find GPS satellite signals, take measurements, and compute its position. An example of an A-GPS positioning system implemented in a Wideband-CDMA network is illustrated in FIG. 1. GPS ranging signals transmitted by GPS satellite vehicles 110 are received at mobile station 120, which is equipped with a GPS receiver. On the network side, a reference GPS receiver 140 continuously collects GPS data from the GPS satellite vehicles 110, and prepares assistance data for transmission to the mobile station 120, via a GPS interface 135 in a Radio Network Controller 130. The Core Network 150 can request positioning reports for individual mobile stations from the RNC 130, via the GPS interface 135. Of course, the network elements and signaling interfaces will differ in an LTE system, but the overall operation is similar.

In any case, the assistance data, when transmitted to GPS receivers in terminals connected to the cellular communication system, enhances the performance of the GPS terminal receivers. In particular, the assistance data aids the mobile station's GPS receiver in rapidly acquiring weak signals from the GPS space vehicles 110, essentially by providing hints as to the expected timing for those signals. As a result, signal acquisition times can be reduced, signal sensitivity improved, or both.

Typically, A-GPS accuracy can be as good as 10 meters, even without differential operation. The accuracy becomes worse in dense urban areas and indoors, where the GPS receiver's sensitivity is inadequate for detection of the very weak signals from the GPS space vehicles. In some cases, it may be impossible for an A-GPS-equipped mobile station to acquire enough GPS signals to determine its location at all, in which case, a back-up positioning technology is desirable. Furthermore, not all mobile stations are equipped with GPS receiver technology. Thus, other positioning technologies are typically used to augment A-GPS-based positioning systems.

Cell ID/Timing-Advance Positioning

The cell identity (ID) positioning method determines a mobile station's location with a granularity equal to the cell size, by simply associating the cell ID for a base station serving a particular mobile station to a geographical description of the cell. In Wideband-Code-Division-Multiple-Access (WCDMA) systems standardized by 3GPP, a polygon with 3-15 corners is used for this purpose. Although this approach has very low accuracy, it is quite reliable.

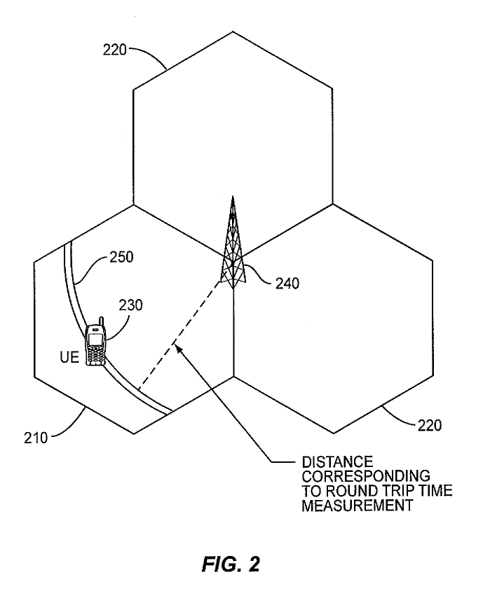

In an LTE system, a simple technique for improving the accuracy of positioning based on cell ID is to combine the geographical information associated with the cell ID with timing advance measurements. The timing-advance positioning principle is depicted in FIG. 2. Briefly, the round-trip travel time (timing advance) of radio waves from the eNodeB 240 to and from the mobile station 230 is measured. The distance r from the eNodeB to the terminal can then be computed according to:

$$r = c \frac{TA}{2} , \qquad ( 1 )$$

where TA is the timing advance value and c is the speed of light. The TA measurement alone defines a circle, or, if the inaccuracy is accounted for, a circular strip 250 around the eNodeB. By combining this information with previously determined geographic descriptions of the cell sectors 210 and 220 served by the cell, left and right angles of the circular strip can be readily computed. As will be seen below, the timing-advance positioning principle is well suited for combination with angle-of-arrival positioning, resulting in an attractive single-cell positioning method.

Fingerprinting Positioning

Another approach to mobile station positioning is called fingerprinting positioning, or RF fingerprinting. This technique is also sometimes used for network mapping. However, fingerprinting techniques are best suited for mapping cell extensions and cell boundaries—these techniques cannot be applied to accurate mapping of eNodeB locations.

Fingerprinting positioning algorithms operate by creating a database of radio fingerprint data for each point of a fine coordinate grid that covers the Radio Access Network (RAN). The fingerprint data may include: the cell IDs that are detected by the terminal, in each grid point; quantized path loss or signal strength measurements, with respect to multiple eNodeBs, performed by a mobile station, in each grid point; quantized timing advance data, in each grid point; and radio connection information, such as the radio access bearer (RAB).

Whenever a position request arrives at a fingerprinting-based positioning node, a radio fingerprint for the subject mobile station is first obtained. This fingerprint data is matched with the fingerprint database to retrieve the corresponding grid point and thus identify the location of the mobile station. Of course, this approach requires that the fingerprint data for each grid point is unique and that the fingerprint data obtained from mobile stations at a given point is relatively consistent.

The database of fingerprinted positions (the radio map) can be generated in several ways. One approach is to perform an extensive surveying operation that performs fingerprinting radio measurements repeatedly for all coordinate grid points of the RAN. The disadvantages of this approach include that the surveying required becomes substantial, even for small cellular networks. Further, some of the radio fingerprint data (e.g. signal strength and path loss) is sensitive to the orientation of the terminal, a fact that is particularly troublesome for handheld mobile stations. For fine grids, the accuracies of the fingerprinted positions therefore become highly uncertain. Unfortunately, these potential problems are seldom reflected in the accuracy estimates reported along with the reported geographical result.

Another approach to RF fingerprinting is to replace the fine grid by high-precision position measurements of opportunity, and to provide fingerprinting radio measurements for said points. This avoids some of the above drawbacks. However, algorithms for clustering of high-precision position measurements of opportunity must be defined, and algorithms for computation of geographical descriptions of the clusters need to be defined.

Time-Difference-of-Arrival (TDOA) Positioning

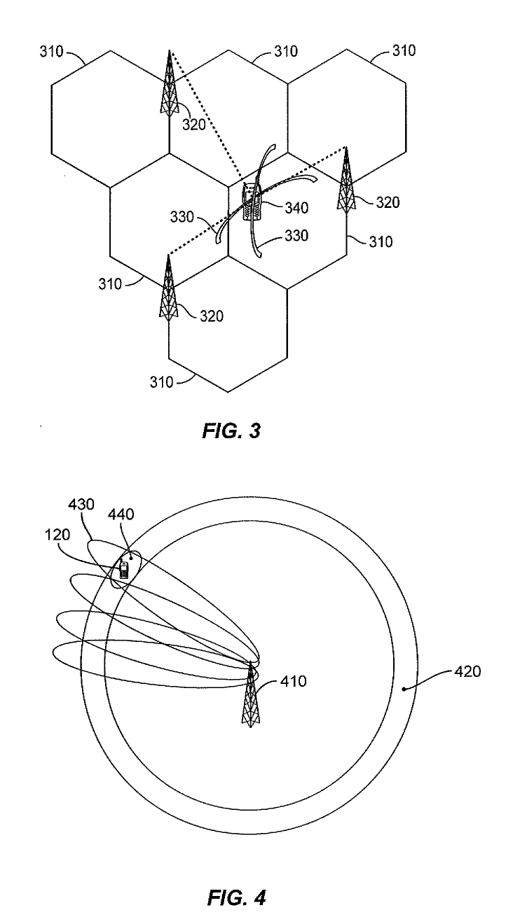

The time-difference of arrival (TDOA) method relies on timing measurements made by a mobile station on signals received from multiple base stations. These measurements are often made on pilot radio signals, by correlating the received signals against a corresponding known signal sequence. FIG. 3 illustrates an exemplary system configuration, in which a mobile station 340 receives signals from three base stations 320, each base station 320 serving one or more cell sectors 310. If the mobile station is able to “hear” signals from all three (or more) of the base stations, and to make time-of-arrival (TOA) measurements for each, then the relationships between the measured TOAs, the transmission times from the base stations (eNodeBs), and the distances between the mobile station and each of the base stations may be expressed as:

t_{TOA,1}+b_{clock}=T₁+∥r₁−r_{Terminal}∥/c

t_{TOA,2}+b_{clock}=T₂+∥r₂−r_{Terminal}∥/c

. . .

t_{TOA,n}+b_{clock}=Tₙ+∥rₙ−r_{Terminal}∥/c. (2)

Here t_{TOA,i}, for i=1, . . . , n, denotes the measured time-of-arrival (TOA) in the terminal for the signal from base station i; Tᵢ, for i=1, . . . , n, denotes the actual transmission times from the eNodeBs (unknown to the mobile station); and c is the speed of light. The boldface quantities rᵢ and r_{Terminal} are the (vector) locations of the base stations and the terminal. b_{clock} denotes the unknown clock bias of the mobile station with respect to cellular system time.

Given the above relationships, time-of-arrival differences between each non-serving base station and the serving base station, from the perspective of the mobile station, may be formed:

t_{DOA,2}=t_{TOA,2}−t_{TOA,1}=T₂−T₁+∥r₂−r_{Terminal}∥/c−∥r₁−r_{Terminal}∥/c

t_{DOA,3}=t_{TOA,3}−t_{TOA,1}=T₃−T₁+∥r₃−r_{Terminal}∥/c−∥r₁−r_{Terminal}∥/c

. . .

t_{DOA,n}=t_{TOA,n}−t_{TOA,1}=Tₙ−T₁+∥rₙ−r_{Terminal}∥/c−∥r₁−r_{Terminal}∥/c. (3)

In these n−1 equations, the left-hand sides are known (albeit with some additional measurement error), from the mobile station measurements. The first pair of terms on the right-hand side also may be assumed to be known to the system. These actual time-of-transmission differences (commonly denoted “real time differences,” or “RTD's”), such as T₂−T₁, can be measured or are otherwise known to the system, such as by virtue of synchronization of base station transmissions to a common reference, such as the global time reference for the GPS system. Further the locations of the base stations, rᵢ, i=1, . . . , n, can be surveyed to within a few meters and are therefore also known to the system. Thus, the only remaining unknown is the terminal location, i.e.:

r_{Terminal}=(x_{Terminal} y_{Terminal} z_{Terminal})^{T}. (4)

Commonly, only a two-dimensional positioning is performed, with the altitude ignored, so that the unknown position is instead:

r_{Terminal}=(x_{Terminal} y_{Terminal})^{T}. (5)

It follows that at least three time of arrival differences are needed in order to find a three-dimensional terminal position, and that at least two time of arrival differences are needed in order to find a two-dimensional terminal position. This, in turn, means that at least four sites need to be detected for three-dimensional terminal positioning and at least three sites need to be detected for two-dimensional terminal positioning. In practice, accuracy can be improved if more measurements are collected and a maximum likelihood solution is introduced. There may also be multiple (false) solutions in cases where only a minimum number of sites are detected.

Angle-of-Arrival Positioning

Angle-of-arrival (AoA) positioning exploits multiple antenna elements to measure the angle of arrival of radio waves impinging on the array. In the uplink it is easy to understand that angles of arrival measured in two or more non-colocated sites in a plane are needed to compute a position in the plane. This makes pure angle-of-arrival positioning a multi-cell technology, a fact that increases the complexity and cost of implementation significantly. Further, in rural regions, base station geometry may not allow measurement of a signal's angle of arrival at multiple eNodeBs.

Hence, a very attractive solution is to combine AoA positioning with TA positioning, in a single cell. Since a signal's AoA and the timing advance are essentially orthogonal metrics of the mobile station's position, the accuracy of such a method should be good, at least in situations where radio propagation is good, i.e., without excessive multipath or other non-line-of-sight effects. These good conditions are particularly likely to be present in rural areas without hills. The principle is depicted in FIG. 4, which illustrates a transmitter 410 capable of forming several (uplink) antenna beams, by virtue of two or more spatially distinct antenna elements. Antenna beam 430 coincides with the position of mobile station 120—thus the center of beam 430 coincides with an estimated angle-of-arrival for signals transmitted by mobile station 410. This angle information may be combined with distance information, indicated by circular strip 420, obtained through analyzing the timing advance for signals received from mobile station 120. Thus, a region 440 corresponding to the intersection of beam 430 and strip 420 may be identified; this region 440 corresponds to an estimated location for the mobile station 120.

Estimating Base Station Positions

The mobile station positioning technologies discussed above all require that the locations of the involved base stations are known. However, as noted above, manual surveying of base stations, whereby personnel measure the positions of the transmitting/receiving antennas with differential GPS, potentially achieving meter-level accuracies, is a large and costly effort. Furthermore, procedures need to be implemented to transfer the information to all positioning nodes of the network, and to keep the information updated at times of cell re-planning. Each of these procedures is susceptible to errors, especially in large and complex networks. Finally, future networks may increasingly rely on smaller base station transceiver nodes that may be occasionally or frequently re-deployed. Such a re-deployment may cause existing databases of base station locations to become out of date. Thus, improved techniques for collecting accurate position estimates for base station transceiver nodes, without costly surveying operations, are needed.

In various embodiments of the invention, as described below, positioning parameters for a base station transceiver node are estimated using signals transmitted from mobile stations for which an accurate location is already known. For example, accurate mobile station positions may be available for one or more Assisted-GPS (A-GPS) capable terminals. Mobile station position information can be combined with measurements of timing advance and/or angle-of-arrival for transmission from those known positions to determine an estimate of a base station transceiver node's position.

Referring once more to FIG. 4, if the position of mobile station 120 is already known, e.g., via A-GPS positioning, then an angle-of-arrival measurement (corresponding to beam 430) and a timing advance measurement (corresponding to range estimate 420) can be combined to determine an estimated position for base station 410. In other words, the angle-of-arrival measurement, referenced to the known position of the mobile station, gives the direction from mobile station 120 to the base station 410. The timing advance measurement gives the distance between the known mobile station position and the base station 410. Hence the position of the base station can be determined easily and unambiguously.

As will be discussed further below, various embodiments of the present invention involve the integration of base station position estimation techniques into a system for automatic detection of faulty configurations of base station coordinates, or into a system for automatically generating a database of base station locations. Thus, those skilled in the art will appreciate that the inventive techniques disclosed herein may be used to assemble a self-learning system for the configuration of base station position information in a wireless network. Those skilled in the art will further appreciate that the inventive techniques disclosed herein may be readily combined with other positioning technologies. For example, fingerprinting technology provides further functionality for a self-learning, self-configuring system, as fingerprinting technology may be used to automatically generate cell polygon descriptions using, for example, the adaptive enhanced cell ID (AECID) positioning method.

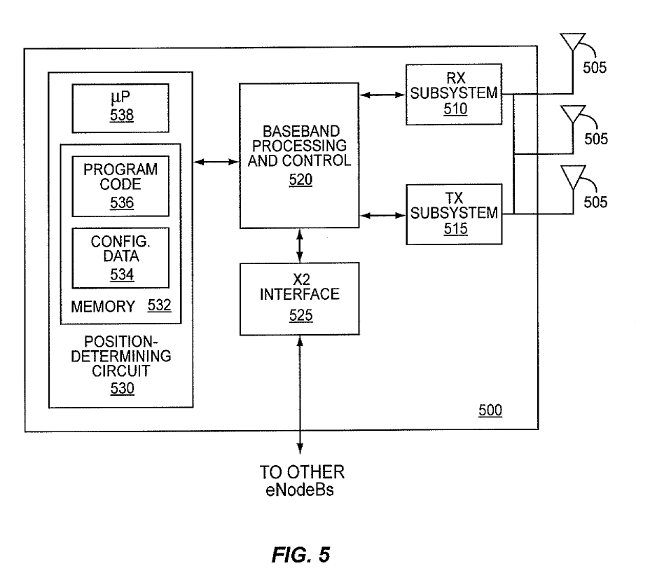

FIG. 5 is a block diagram illustrating several functional components of an exemplary base station 500, in this case an LTE eNodeB, according to some embodiments of the invention. The pictured eNodeB 500 includes a receiver subsystem 510, a transmitter subsystem 515, a baseband processing and control circuit 520, and a position-determining circuit 530. As will be discussed in further detail below, signals from mobile stations having known or ascertainable locations are received via two or more antenna elements 505, and processed by receiver subsystem 510, which may include conventional analog and digital circuitry suitably configured to receive and process radio signals formatted according to one or more wireless communication standards, such as the 3GPP standards for LTE systems. One or more of the antenna elements 505 may be connected to transmitter subsystem 515 as well, permitting use of beam-forming and/or multiple-input multiple-output techniques for transmissions to mobile stations served by base station 500.

Baseband processing and control section 520 processes signals received from receiver subsystem 510 and signals to be sent to transmitter subsystem 515. In particular, baseband processing control section is configured to execute a base station protocol stack according to one or more wireless communications standards, such as the LTE standards. Baseband processing and control section 520 communicates with other eNodeBs via an X2 interface 525, and communicates with the core network via an S1 interface (not shown). Of course, those skilled in the art will appreciate that the standard-specific features of base station 500 are described for illustrative purposes only—the inventive techniques described herein may be applied to determining base station positions in wireless networks of various types.

Exemplary position-determining circuit 530 includes one or more microprocessors 538 and memory 532. Memory 532, which may comprise one or several types of memory devices, such as Flash, RAM, ROM, magnetic storage, optical storage, or the like, is configured to store program code 536 for execution by microprocessor(s) 538, including program code defining instructions for estimating the position of base station 500 according to one or more of the methods described herein. Like the overall illustration of base station 500, the particular configuration of position-determining circuit 530 illustrated here is illustrative, and not limiting—those skilled in the art will recognize that processing circuits of varying configuration may be used to implement the inventive methods and techniques described herein. In particular, those skilled in the art will appreciate that position-determining circuit 530 in some embodiments may comprise a physically distinct circuit from other circuits in base station 500, such as the circuits for baseband processing and control section 520, but may also share one or more components, such as one or more microprocessors or memory devices, with other base station processing functions in other embodiments. Furthermore, although position-determining circuit 530 forms part of the base station 500 in the particular embodiment illustrated in FIG. 5, all or part of a similar position-determining circuit may reside elsewhere in a communications network, such as in a centralized positioning node, in other embodiments of the present invention.

Even more generally, those skilled in the art will appreciate that position-determining circuit 530 may comprise any of a variety of physical configurations, such as in the form of one or more application-specific integrated circuits (ASICs). In many of these embodiments, position-determining circuit 530 may comprise one or more microprocessors, microcontrollers, and/or digital signal processors, each of which may be programmed with appropriate software and/or firmware to carry out all or part of one or more of the processes described above, or variants thereof. In some embodiments, position-determining circuit 530 may comprise customized hardware to carry out one or more of the functions described above.

The operation of the position-determining circuit 530 may be understood by referring once again to FIG. 4. If mobile station 440 is assumed to first determine its own location, e.g., using A-GPS positioning, then its location can be represented as:

rᵢ^{AGPS}=(xᵢ^{AGPS} yᵢ^{AGPS})^{T}. (6)

where i indexes the mobile station. (As will be seen below, transmissions from several different mobile stations may be used to determine a base station's position, in some cases.) The mobile station's location information is signaled to a network node where further processing takes place. In some of the examples discussed herein that network node is an eNodeB, such as the eNodeB 500 illustrated in FIG. 5. However, the base station position-determining techniques described herein may be performed at some other network node, such as in a central location-based services server, provided that the node has access to the mobile station location information as well as the base station measurements discussed below.

In any case, referring once more to FIG. 4 and the operation of an exemplary position-determining circuit 520, a timing advance value TAᵢ corresponding to a transmission from mobile station 120 is measured. Further, an angle-of-arrival αᵢ corresponding to that transmission or a second transmission close in time to the first is measured. Both of these measurements are preferably made during a time interval extending from shortly before to shortly after the mobile station's location is determined, so that the transmissions correspond closely to the determined location. Those skilled in the art will appreciate that errors in the ultimate determination of the base station's position will depend in part on the length of time between the timing advance measurement and/or angle-of-arrival and the position fix for the mobile, if the mobile station is moving.

In any case, the timing advance measurement data TAᵢ and angle-of-arrival data αᵢ (which may have been originally collected by RX subsystem 510 and baseband processing and control circuit 520, for example), is collected by the position-determining circuit 530. The position-determining circuit 530 also receives mobile station location data identifying the mobile station position corresponding to the timing advance and angle-of-arrival data—this data may be received via a control plane transmission of the location data from the mobile station 120 to the eNodeB 500, for example, or received at the position-determining circuit 530 in response to a request to a central positioning node for the mobile station's position, for another example. Given this information, the position-determining circuit 530 may compute an estimated eNodeB position as follows:

$$\begin{matrix}{r}_{i}^{eNodeB} = {( \begin{matrix}{x}_{i}^{eNodeB} & {y}_{i}^{eNodeB}\end{matrix} )}^{T} \\ = {( \begin{matrix}{x}_{i}^{AGPS} & {y}_{i}^{AGPS}\end{matrix} )}^{T} + \frac{{cTA}_{i}}{2} {( \begin{matrix}cos ( {α}_{i} ) & sin ( {α}_{i} )\end{matrix} )}^{T} + \\ {( \begin{matrix}{e}_{i , x}^{eNodeB} & {e}_{i , y}^{eNodeB}\end{matrix} )}^{T}\end{matrix} \qquad ( 7 )$$

where (e_{i,x}^{eNodeB} e_{i,y}^{eNodeB})^{T} denotes the estimation error that results from errors in each of the mobile station's position and the timing advance and angle-of-arrival measurements.

Since a typical inaccuracy of the timing advance measurement in LTE systems may be on the order of a few hundred meters, and since the inaccuracy of the angle-of-arrival measurement may be several degrees, it follows that the estimation error affecting the eNodeB position determination may be substantial, especially for large cells, where inaccuracies in the angle-of-arrival measurements translate to large errors in the base station coordinates. One approach to improving the ultimate base position estimate is to apply averaging of several positioning parameter measurements. For example, if the calculation of Equation (7) is repeated for N mobile stations, each with a known location, then the base station's position can be estimated according to:

$$〈 {r}^{eNodeB} 〉 = \frac{1}{N} {\sum }_{i = 1}^{N} {r}_{i}^{eNodeB} . \qquad ( 8 )$$

Of course, those skilled in the art will appreciate that this technique does not necessarily require that multiple mobile stations are used. Instead, multiple positioning parameter measurements corresponding to transmissions from the same mobile station, but at different (known) locations may also be used, in the same manner, to produce an improved estimate of the base station's position.

Those skilled in the art will also appreciate that variations of the technique described above are possible. For example, it is possible to determine an estimate of a base station's position without using timing advance information. Of course, this may be less interesting in practice, since timing advance data for a given transmission may already be available. However, especially in situations where the timing advance data is subject to bias, or when highly accurate angle-of-arrival measurements are available, an estimation of the base station's position computed entirely from a combination of angle-of-arrival measurements from several mobile stations may be of interest.

Given several angle-of-arrival estimates αᵢ, measured from the perspective of an eNodeB receiving transmissions from N mobile stations, it follows that the eNodeB is located somewhere on lines corresponding to each measurement:

rᵢ^{eNodeB}(rᵢ)=(xᵢ^{AGPS} yᵢ^{AGPS})^{T}+rᵢ(cos(αᵢ) sin(αᵢ))^{T}, (9)

for i=1, . . . , N, where rᵢ is the unknown distance between the eNodeB and mobile station i. Denoting the position of the eNodeB as (x^{eNodeB} y^{eNodeB})^{T}, the following minimization problem can be posed to obtain the solution:

$$\begin{matrix} V ( \begin{matrix}{r}_{1} , … , {r}_{N} , \\ {x}^{eNodeB} , {y}^{eNodeB}\end{matrix} ) = \frac{1}{N} {\sum }_{i = 1}^{N} {‖ \begin{matrix}( \begin{matrix}{x}^{eNodeB} \\ {y}^{eNodeB}\end{matrix} ) - ( \begin{matrix}{x}^{AGPS} \\ {y}^{AGPS}\end{matrix} ) - \\ {r}_{i} ( \begin{matrix}cos ( {α}_{i} ) \\ sin ( {α}_{i} )\end{matrix} )\end{matrix} ‖}_{2}^{2} \\ and \text{:} & ( 10 ) \\ ( \begin{matrix}{\hat{x}}^{eNodeB} \\ {\hat{y}}^{eNodeB}\end{matrix} ) = ( \begin{matrix}1 & 0 & 0 & … & 0 \\ 0 & 1 & 0 & … & 0\end{matrix} ) {argmin}_{{r}_{1} , … , {r}_{n} , {x}^{eNodeB} , {y}^{eNodeB}} V ( \begin{matrix}{r}_{1} , … , {r}_{N} , \\ {x}^{eNodeB} , {y}^{eNodeB}\end{matrix} ) . & ( 11 )\end{matrix}$$

Those skilled in the art will appreciate that there are N+2 variables to compute, but 2N equations available. Hence, the problem can be solved for N≧2. This is the same result that would be expected by intuition—angle-of-arrival measurements for transmissions from two or more mobile stations at different known locations (or from a single mobile station at two or more different locations) may be used to estimate the two-dimensional position of the base station receiving the transmissions. Those skilled in the art will also appreciate that the optimization problem given above in Equations (10) and (11) could readily be extended by adding one or more timing advance measurements, e.g., by adding an equation for the circle corresponding to each timing advance measurement. Although not detailed here, this extension may be performed in various embodiments of the invention, to further improve accuracy and/or robustness of the positioning determining process.

In view of the techniques described above, a process flow illustrating an exemplary method for determining a position estimate for a base station transceiver node in a wireless communication system is shown in FIG. 6. This process, or variants of it, may be implemented in a position-determining circuit configured for use in or in association with the base station transceiver node of interest, for example, such as the position-determining circuit 530 illustrated in FIG. 5.

The process illustrated in FIG. 6 begins, as shown at block 610, with the estimation of a first angle-of-arrival for a transmission from a first mobile station. Specific techniques for performing angle-of-arrival measurements, using multiple receiving antenna elements, are well known to those skilled in the art, and are therefore not detailed here.

Those same techniques may be used again, as shown at block 620, for estimating a second angle-of-arrival for a transmission from a second mobile station, or a second transmission from the first mobile station, at a second location. Alternatively, in the pictured embodiment, a time-of-arrival measurement for the first transmission may be made—this time-of-arrival may be compared with the base station's transmitter timing to determine a timing advance value for the mobile station, which corresponds directly to the round-trip distance between the base station transceiver node and the mobile station.

At block 630, location data identifying the mobile station location corresponding to each measurement is received. In the event that an angle-of-arrival measurement and a timing advance measurement corresponding to a single transmission are used, then only a single mobile station location corresponding to that transmission is needed. If two (or more) angle-of-arrival measurements are instead used, corresponding to two or more transmissions from different locations, then a mobile station location corresponding to each transmission location is needed.

At block 640, an estimated position for the base station position is computed from the mobile station location data, the first angle-of-arrival estimate, and the second angle-of-arrival estimate or timing advance estimate. This computation may be performed, for example, using Equation (7), for a combination of angle-of-arrival data and timing advance data. Alternatively, the optimization problem of Equations (10) and (11) may be used if multiple angle-of-arrival measurements are used. Those skilled in the art will recognize, of course, that variants and/or combinations of these formulations may be used instead, in some embodiments of the invention.

Once a base station position estimate has been obtained, it may be used in several ways. For instance, the base station position estimate may be subsequently used to estimate mobile station positions, such as for mobile stations that are not equipped with GPS. The estimated base station position determined according to the techniques described above may be used, for example, with any of the conventional mobile station positioning techniques described earlier. This is illustrated in the process flow diagram of FIG. 8. The illustrated process begins, as shown at block 810, with the computation of a base station position estimate using any of the techniques described above. As shown at block 820, measurement data is received from a mobile station of interest—this measurement data might include a timing advance value, time-difference-of-arrival data, or the like. This data is then used, along with the estimated base station position, to compute an estimated mobile station location, as shown at block 830.

In some systems, after estimating an eNodeB's coordinates according to the steps disclosed above, the eNodeB coordinates (or, in some embodiments, the underlying measurement data needed for determination of the eNodeB coordinates) are sent from the eNodeB to a supporting network node where coordinates for several eNodeBs in the system are stored and/or configured. The newly received (or newly calculated) eNodeB coordinates may be compared to previously stored coordinates for that eNodeB. A significant difference, e.g., a difference exceeding a pre-determined threshold, may indicate a configuration error. In some embodiments, this configuration error may trigger a notification, so that action may be taken by network operator personnel. In other embodiments, the stored configuration data for that eNodeB may simply be replaced and/or updated with the new estimated position, or the average of several estimates for the base station.

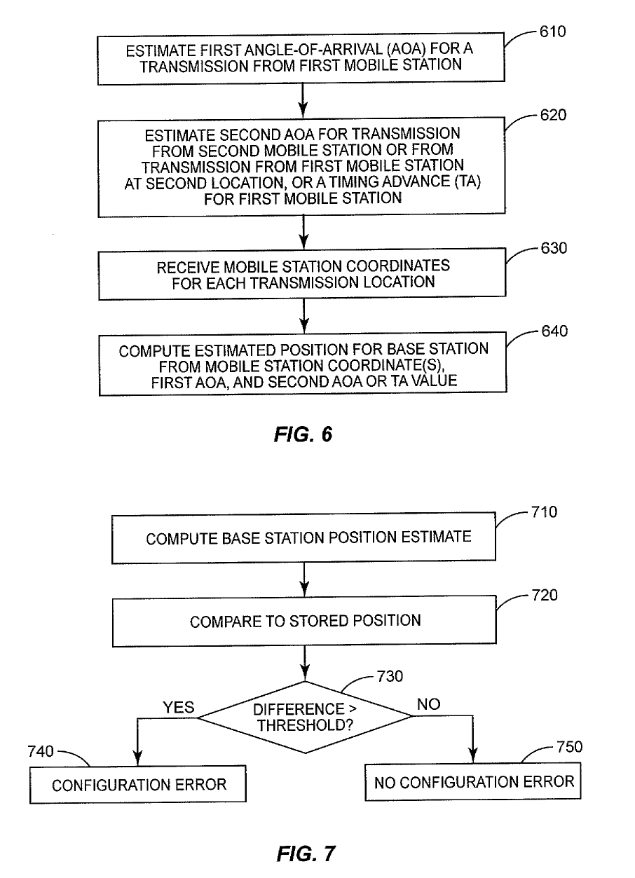

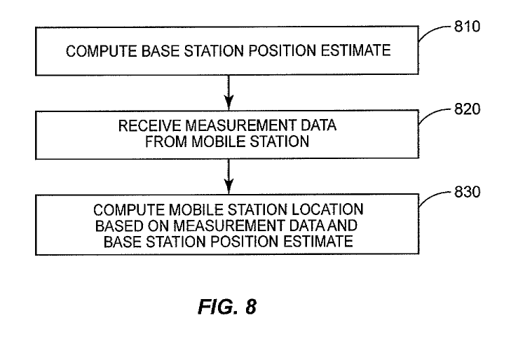

A process flow diagram illustrating the above technique is given in FIG. 7. After a base station position estimate is computed, as shown at block 710, it is compared to a stored position for the base station, as shown at block 720. If the difference is less than a pre-determined configuration error threshold then there is no configuration error, as shown at blocks 730 and 750. On the other hand, if the difference exceeds the configuration error threshold, as shown at blocks 730 and 740, then a configuration error has occurred and further action (either automatic, or by network operator personnel) is required.

A similar process may be carried out in a wireless network configured for “self learning” of base station transceiver positions. In these systems, an estimated position for a given eNodeB may be carried out according to the techniques described above. This estimated position (or the underlying measurement data) is again sent to the network node where several eNodeB coordinates are stored and/or configured. After receiving these eNodeB coordinates, this network node checks to determine whether eNodeB coordinates are already in place for said eNodeB. If not, the newly received (or newly computed) coordinates are simply stored in the database. Otherwise, in various embodiments, the new position estimate may be discarded, or used to update the previously existing coordinates.

In the discussion above, various automatic procedures for mapping of base station positions have been disclosed. Corresponding apparatus, including exemplary position-determining circuits configured to carry out one or more of these procedures have also been disclosed. Those skilled in the art will appreciate that still other embodiments of the invention may include computer-readable devices, such as a programmable flash memory, an optical or magnetic data storage device, or the like, encoded with computer program instructions which, when executed by an appropriate processing device, cause the processing device to carry out one or more of the techniques described herein for estimating the position of a base station transceiver node in a wireless communication network.

Those skilled in the art will appreciate that these methods and corresponding apparatus and devices have the potential to reduce RAN mapping costs of operators significantly, in some embodiments, compared to manual surveying techniques. Some of the inventive techniques disclosed herein also have the potential to improve management of base station position databases, by providing means for automatic detection of faults in the base station position data. Of course, those skilled in the art will recognize that the present invention may be carried out in other ways than those specifically set forth herein without departing from essential characteristics of the invention. The present embodiments are thus to be considered in all respects as illustrative and not restrictive, and all changes coming within the scope of the appended claims are intended to be embraced therein.

What is claimed is:

1. A method for determining a position estimate for a base station transceiver node in a wireless communication system, comprising:
determining a first estimated angle-of-arrival corresponding to a first mobile station transmission, from a first mobile station location, received at the base station transceiver node;
determining at least one additional estimated positioning parameter, comprising one or more of (i) an estimated timing advance value for the first mobile station transmission or (ii) a second estimated angle-of-arrival corresponding to a second mobile station transmission, from a second mobile station location, received at the base station transceiver node;
receiving mobile station location data identifying the first mobile station location and any additional mobile station locations corresponding to the at least one additional estimated positioning parameter; and
computing an estimated position for the base station transceiver node as a function of the mobile station location data, the first estimated angle-of-arrival, and the at least one additional estimated positioning parameter.

2. The method of claim 1, wherein determining the first estimated angle-of-arrival comprises estimating the first estimated angle-of-arrival based on signals received from two or more antenna elements co-located with the base station transceiver node.

3. The method of claim 1, wherein determining at least one additional estimated positioning parameter comprises estimating a timing advance value for the first mobile station transmission, and wherein computing an estimated position for the base station transceiver node comprises:
calculating base station coordinate offsets as a function of the first angle-of-arrival and the timing advance value; and
calculating the estimated position as a function of the first mobile station location and the computed base station coordinate offsets.

4. The method of claim 3, wherein the estimated position is calculated further as a function of mobile station location data corresponding to one or more additional mobile station transmissions and additional base station coordinate offsets corresponding to the one or more additional mobile station transmissions.

5. The method of claim 1, wherein determining at least one additional estimated positioning parameter comprises estimating a second angle-of-arrival corresponding to either a transmission by a second mobile station, from a second mobile station location, or a transmission by the first mobile station from a second mobile station location, and wherein computing an estimated position for the base station transceiver node comprises solving an optimization problem based on the first and second estimated angles-of-arrival and mobile station location data corresponding to the first and second mobile station locations.

6. The method of claim 5, wherein the estimated position is calculated further as a function of a third estimated angle-of-arrival corresponding to a third transmission from a third mobile station location and mobile station location data corresponding to the third mobile station location.

7. The method of claim 1, further comprising updating stored position coordinates for the base station transceiver node based on the estimated position.

8. The method of claim 1, further comprising detecting an error in stored position coordinates for the base station transceiver node by:
comparing the estimated position to the stored position coordinates; and
determining that the difference between the estimated position and the stored position coordinates exceeds a pre-determined threshold.

9. The method of claim 1, further comprising sending the estimated position to a supporting node in the wireless communication system.

10. The method of claim 1, further comprising subsequently using the estimated position to calculate an estimated mobile position for one or more mobile stations.

11. A position-determining circuit configured for use in or in association with a base station transceiver node in a wireless communication system, wherein the position-determining circuit is configured to:
determine a first estimated angle-of-arrival corresponding to a first mobile station transmission, from a first mobile station location, received at the base station transceiver node;
determine at least one additional estimated positioning parameter, comprising one or more of (i) an estimated timing advance value for the first mobile station transmission or (ii) a second estimated angle-of-arrival corresponding to a second mobile station transmission, from a second mobile station location, received at the base station transceiver node;
receive mobile station location data identifying the first mobile station location and any additional mobile station locations corresponding to the at least one additional estimated positioning parameter; and
compute an estimated position for the base station transceiver node as a function of the mobile station location data, the first estimated angle-of-arrival, and the at least one additional estimated positioning parameter.

12. The position-determining circuit of claim 11, configured to estimate the first angle-of-arrival based on signals received from two or more antenna elements co-located with the base station transceiver node.

13. The position-determining circuit of claim 11, configured to determine the at least one additional estimated positioning parameter by estimating the timing advance value for the first mobile station transmission, and further configured to compute the estimated position for the base station transceiver node by:
calculating base station coordinate offsets as a function of the first estimated angle-of-arrival and the estimated timing advance value; and
calculating the estimated position as a function of the first mobile station location and the computed base station coordinate offsets.

14. The position-determining circuit of claim 13, configured to compute the estimated position further as a function of mobile station location data corresponding to one or more additional mobile station transmissions and additional base station coordinate offsets corresponding to the one or more additional mobile station transmissions.

15. The position-determining circuit of claim 11, configured to determine the at least one additional estimated positioning parameter by estimating a second angle-of-arrival corresponding to either a transmission by a second mobile station, from a second mobile station location, or a transmission by the first mobile station from a second mobile station location, and configured to compute the estimated position for the base station transceiver node by solving an optimization problem based on the first and second estimated angles-of-arrival and mobile station location data corresponding to the first and second mobile station locations.

16. The position-determining circuit of claim 15, configured to compute the estimated position further as a function of a third angle-of-arrival corresponding to a third transmission from a third mobile station location and mobile station location data corresponding to the third mobile station location.

17. The position-determining circuit of claim 11, further configured to update stored position coordinates for the base station transceiver node based on the estimated position.

18. The position-determining circuit of claim 11, further configured to detect an error in stored position coordinates for the base station transceiver node by:
comparing the estimated position to the stored position coordinates; and
determining that the difference between the estimated position and the stored position coordinates exceeds a pre-determined threshold.

19. The position-determining circuit of claim 11, further configured to send the estimated position to a supporting node in the wireless communication system.

20. The position-determining circuit of claim 11, further configured to subsequently use the estimated position to calculate an estimated mobile position for one or more mobile stations.

21. A base station transceiver node in a wireless communication system, comprising a receiver circuit configured to receive mobile station transmissions via two or more antennas, and a position-determining circuit configured to:
estimate a first angle-of-arrival corresponding to a first mobile station transmission, from a first mobile station location, received at the base station transceiver node;
estimate at least one additional positioning parameter, comprising one or more of (i) a timing advance value for the first mobile station transmission or (ii) a second angle-of-arrival corresponding to a second mobile station transmission, from a second mobile station location, received at the base station transceiver node;
receive mobile station location data identifying the first mobile station location and any additional mobile station locations corresponding to the at least one additional positioning parameter; and
compute an estimated position for the base station transceiver node as a function of the mobile station location data, the first angle-of-arrival, and the at least one additional positioning parameter.
